(19) United States
(12) Patent Application Publication
(10) Pub. No.: US 2025/0259758 A1
(43) Pub. Date: Aug. 14, 2025

(54) IMPROVED NUCLEAR FUEL ASSEMBLY WITH ENHANCED SEISMIC PERFORMANCE AND CONTROL ROD WORTH

(71) Applicant: KEPCO NUCLEAR FUEL CO., LTD., Daejeon (KR)

(72) Inventors: Joo Young RYU, Daejeon (KR); Dong Geun HA, Daejeon (KR); Shin Ho LEE, Daejeon (KR); Seong Soo KIM, Gwangju (KR); Kyounghong KIM, Daejeon (KR); Dae Woon CHOI, Daejeon (KR); Hak In LEE, Sejong (KR); Ju Yeob YOON, Daejeon (KR); Chae Young NAM, Daejeon (KR)

(73) Assignee: KEPCO NUCLEAR FUEL CO., LTD., Daejeon (KR)

(21) Appl. No.: 18/965,970

(22) Filed: Dec. 2, 2024

(30) Foreign Application Priority Data
Jan. 2, 2024 (KR) 10-2024-0000467

(51) Int. Cl. G21C 3/344; G21C 3/328; G21C 3/33; G21C 7/117

(52) U.S. Cl. CPC G21C 3/344; G21C 3/328; G21C 3/3305; G21C 3/3315; G21C 7/117

(57) ABSTRACT

Disclosed is a nuclear fuel assembly suitable for a small modular reactor (SMR), wherein the nuclear fuel assembly includes a spacer grid having 17×17 lattice cells, a plurality of fuel rods, each arranged within an associated lattice cell of the spacer grid, guide tubes, each arranged and fixed within an associated lattice cell of the spacer grid, and a top nozzle and a bottom nozzle fixed to an upper end and a lower end of each guide tube, respectively, wherein, with respect to a center cell of the spacer grid, each of eight guide tubes is arranged in an associated one of principal axis directions Ixx and Iyy, each of four guide tubes in an associated one of on-diagonal directions Ixy, and each of 16 guide tubes in an associated one of off-diagonal directions Ixxy and Ixyy.

### CROSS REFERENCE TO RELATED APPLICATION

The present application claims priority to Korean Patent Application No. 10-2024-0000467, filed Jan. 2, 2024, the entire contents of which are incorporated herein for all purposes by this reference.

### BACKGROUND

### Technical Field

The present disclosure relates to a nuclear fuel assembly suitable for a small modular reactor (SMR).

### Description of the Related Art

A core of a typical light water reactor has a number of nuclear fuel assemblies, each of which includes a plurality of long fuel rods and a plurality of guide tubes, which is in the form of tubes used to guide control rods during their movement. The guide tubes are fixed to a top nozzle and a bottom nozzle of the nuclear fuel assembly, providing a skeleton of the nuclear fuel assembly.

Control rods contain a material that absorbs neutrons generated during a fission process. Conventionally, materials with high neutron capture cross sections, such as boron carbide (B₄C), hafnium (H_{f}), or silver-indium-cadmium (Ag—In—Cd), have been used.

The nuclear fuel assemblies of general light water reactors, including a domestic nuclear power plant model APR1400, are the same regardless of whether they are in the control rod or non-control rod positions inside the core, and all nuclear fuel assemblies have guide tubes even when used in the core position where there are no guided control rods, and these guide tubes are used to provide a single skeleton of the nuclear fuel assemblies.

A typical nuclear fuel assembly consists of a 17×17 grid with a total of 289 cells. Of these, 264 cells contain fuel rods, 24 cells contain guide tubes, and the remaining cell, located at the center of the grid, contains an instrumentation tube.

Meanwhile, development is underway on a small modular reactor (SMR) that drastically reduces the size and output of traditional reactors. Theoretically, the SMR has the advantage of being small in size, making output control and reactor cooling easier.

The foregoing is intended merely to aid in the understanding of the background of the present disclosure, and is not intended to mean that the present disclosure falls within the purview of the related art that is already known to those skilled in the art.

### DOCUMENTS OF RELATED ART

### Patent Document

(Patent Document 1) Korean Patent Publication No. 10-1994-0003796 (Published on May 3, 1994)

(Patent Document 2) Korean Patent Publication No. 10-1992-0007739 (Published on Sep. 16, 1992)

### SUMMARY

Accordingly, the present disclosure has been made keeping in mind the above problems occurring in the related art, and the present disclosure is intended to provide a nuclear fuel assembly suitable for a small modular reactor (SMR).

In order to achieve the above objective, a nuclear fuel assembly according to the present disclosure may be provided, the nuclear fuel assembly including: a spacer grid provided with 17×17 lattice cells; a plurality of fuel rods, each arranged within an associated lattice cell of the spacer grid; guide tubes, each arranged and fixed within an associated lattice cell of the spacer grid; and a top nozzle and a bottom nozzle fixed to an upper end and a lower end of each guide tube, respectively, wherein, with respect to a center cell of the spacer grid, each of eight guide tubes is arranged in an associated one of principal axis directions Ixx and Iyy, each of four guide tubes in an associated one of on-diagonal directions Ixy, and each of 16 guide tubes in an associated one of off-diagonal directions Ixxy and Ixyy.

The guide tubes may each be arranged at (6,0), (3,0), (−3,0), (−6,0) and (0,6), (0,3), (0,−3), and (0,−6) in an associated one of the principal axis directions.

The guide tubes may each be arranged at (5,5), (−5,−5, (−5,5), and (5,−5) in an associated one of the on-diagonal directions.

The guide tubes may each be arranged at (6,3), (4,2), (−4,−2), (−6,−3), (−6,3), (−4,2), (4,−2), (6,−3), (3,6), (2,4), (−2,−4), (−3,−6), (−3,6), (−2,4), (2,−4), and (3,−6) in an associated one of the off-diagonal directions.

Next, a spacer grid assembly may include: a spacer grid provided with 17×17 lattice cells; sleeves, each fixed and assembled within an associated lattice cell of the spacer grid, wherein, with respect to a center cell of the spacer grid, each of eight sleeves is arranged in an associated one of principal axis directions Ixx and Iyy, each of four sleeves in an associated one of on-diagonal directions Ixy, and each of 16 sleeves in an associated one of off-diagonal directions Ixxy and Ixyy.

The sleeves may each be arranged at (6,0), (3,0), (−3,0), (−6,0), (0,6), (0,3), (0,−3), and (0,−6) in an associated one of the principal axis directions.

The sleeves may each be arranged at (5,5), (−5,−5), (−5,5), and (5,−5) in an associated one of the on-diagonal directions.

The sleeves may each be arranged at (6,3), (4,2), (−4,−2), (−6,−3), (−6,3), (−4,2), (4,−2), (6,−3), (3,6), (2,4), (−2,−4), (−3,−6), (−3,6), (−2,4), (2,−4), and (3,−6) in an associated one of the off-diagonal directions.

As described above, a nuclear fuel assembly according to the present disclosure may include a spacer grid having 17×17 lattice cells, a plurality of fuel rods arranged within the lattice cells of the spacer grid, guide tubes respectively arranged and fixed within associated lattice cells of the spacer grid, and a top nozzle and a bottom nozzle respectively fixed to an upper end and a lower end of each of the guide tubes,
wherein, a total of 28 guide tubes are provided in such a way that, with respect to a center cell of the spacer grid, eight guide tubes are arranged in principal axis directions Ixx and Iyy, four in on-diagonal directions Ixy, and 16 in off-diagonal directions Ixxy and Ixyy. As a result, the present disclosure may achieve the following effects, which may enhance the control rod worth and seismic performance.

### 1) Improvement of Control Rod Worth for Boric Acid-Free Core Operation

A typical commercial pressurized water reactor is operated with the control rods fully withdrawn for most of the time, and the excess reactivity is controlled by soluble boric acid and combustible absorbing rods. On the other hand, the recent development of small modular reactors is being carried out with a boric acid-free core as the top priority. Therefore, insertion of the control rods is required from the beginning of the cycle for the small modular reactors. A remaining excess reactivity (no greater than 1000 pcm) may be controlled to a critical state (keff=1.0) by inserting regulating control rods. Therefore, the present invention may satisfy the subcriticality requirement by improving the control rod worth.

### 2) Enhancement of Seismic Performance

The present invention increases the number of guide tubes fixed to the top nozzle and the bottom nozzle. This increases the bending rigidity of the skeleton of the nuclear fuel assembly, reduces the displacement of the nuclear fuel assembly at the same energy level with increased natural frequency, and also reduces the load generated. Therefore, the present invention may enhance seismic performance.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a front view of a nuclear fuel assembly according to an embodiment of the present disclosure;

FIG. 2 is a plan view showing an arrangement pattern of fuel rods in a spacer grid assembly according to the embodiment of the present disclosure;

FIG. 3 is a plan view of a control rod assembly according to the embodiment of the present disclosure;

FIG. 4 is a graph showing results of a subcriticality evaluation under ARI and N-1 conditions based on the 24-pin control rod, wherein N-1 conditions refer to insertion conditions of all (N-1) control rods excluding one control rod with the largest control rod worth from all N control rods; and

FIG. 5 is a graph showing results of a subcriticality evaluation under ARI and N-1 conditions based on the 28-pin control rod, wherein N-1 conditions refer to insertion conditions of all (N-1) control rods excluding one control rod with the largest control rod worth from all N control rods.

### DETAILED DESCRIPTION

Specific structural or functional descriptions presented in the embodiments of the present disclosure are merely exemplified for the purpose of explaining embodiments according to the concept of the present disclosure, and embodiments according to the concept of the present disclosure may be implemented in various forms. In addition, the descriptions presented should not be construed as being limited to the embodiments described in the present specification but should be understood to include all modifications, equivalents, or substitutes included in the spirit and scope of the present disclosure.

Meanwhile, the terms used in this specification are only used to describe specific embodiments and are not intended to limit the present disclosure. Singular expressions include plural expressions unless the context clearly indicates otherwise. It should be understood that the terms “comprise” or “have” as used herein are intended to specify the presence of an implemented feature, number, step, operation, component, part, or combination thereof, but do not exclude in advance the possibility of the presence or addition of one or more other features, numbers, steps, operations, components, parts, or combinations thereof.

Hereinafter, embodiments of the present disclosure will be described in detail with reference to the accompanying drawings.

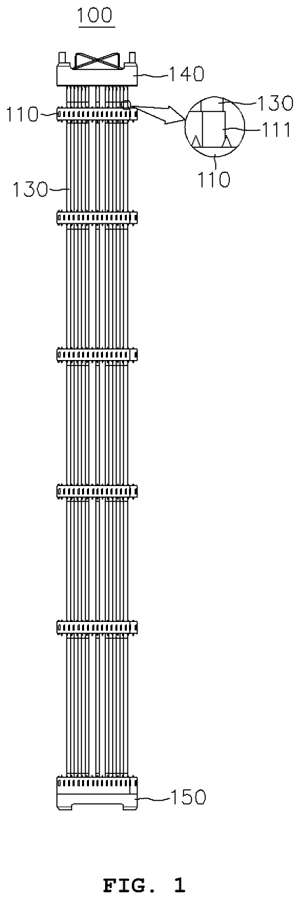

FIG. 1 is a front view of a nuclear fuel assembly according to an embodiment of the present disclosure and omitted with the fuel rods.

With reference to FIG. 1, the nuclear fuel assembly 100 of the present embodiment includes a spacer grid 110, guide tubes 130, each arranged and fixed within an associated lattice cell of the spacer grid 110, and a top nozzle 140 and a bottom nozzle 150, respectively fixed to an upper end and a lower end of each guide tube 130. The fuel rods are supported on the spacer grid 110 and arranged axially parallel to the guide tubes 130.

The top nozzle 140 may be provided with a coil spring or a plate spring to provide a pressing force against the axial movement of the nuclear fuel assembly, and the bottom nozzle 150 may be provided with a nozzle where coolant is introduced.

The spacer grid 110 is assembled so that a plurality of straps is assembled in the horizontal and vertical directions to have a lattice shape, and one fuel rod or guide tube is placed inside each square lattice cell partitioned by the straps.

The spacer grid 110 elastically supports the fuel rods with dimples and grid springs provided within the lattice cells into each of which the fuel rod is inserted. The spacer grid 110 may also fix the guide tubes with the mediation of sleeves, mounted inside dimples and grid springs provided within the lattice cells into each of which the guide tube 130 is inserted. Meanwhile, though it is shown in FIG. 1 that the spacer grid 110 includes a sleeve 111 that is assembled with the guide tube 130, the spacer grid 110 and the guide tube 130 may also be fixed by direct welding. Spacer grids 110 are typically manufactured using sheet metal processing and welding but may also be produced with a metal 3D printing device and are not limited to a specific manufacturing method.

The spacer grid 110 may consist of 17×17 lattice cells, with a total of 28 guide tubes 130 arranged at specific positions among them. An embodiment thereof will be described in detail below.

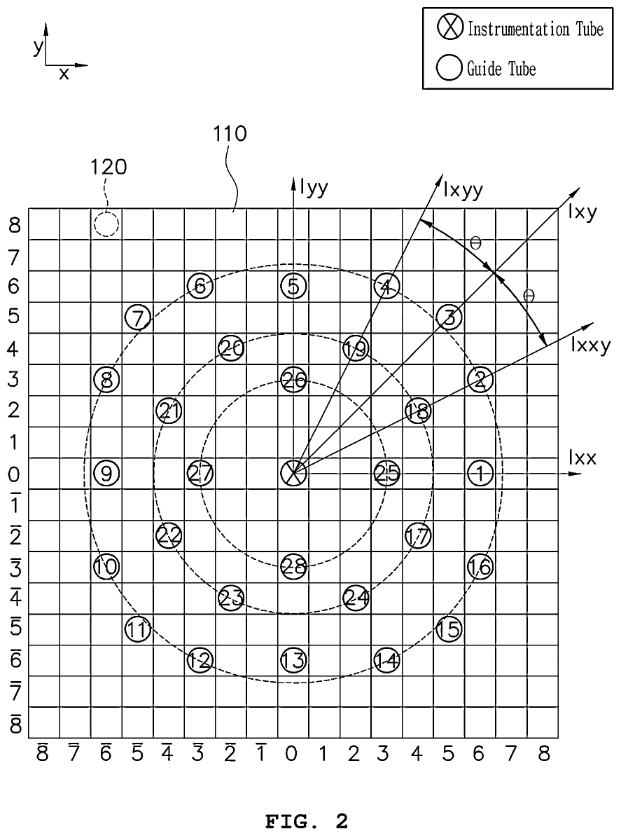

FIG. 2 is a plan view showing an arrangement pattern of fuel rods in a spacer grid assembly according to the embodiment of the present disclosure, and to help understanding, the horizontal direction of the spacer grid 110 is the x-axis, the vertical direction is the y-axis, and the location of a specific lattice cell is indicated in a two-axis coordinate system (x, y), and the coordinate of the center cell is indicated as (0,0). In FIG. 2, 1̅ indicates −1.

With reference to FIG. 2, the spacer grid 110 is composed of 17×17 lattice cells, the center cell (0,0) has an instrumentation tube positioned, a total of 28 guide tubes are arranged at specific locations, and fuel rods 120 are arranged in the remaining lattice cells. However, the fuel rods are omitted in FIG. 2.

In the description of the present disclosure, based on the center cell (0,0), the principal axis direction refers to the horizontal direction Ixx and the vertical direction Iyy of the spacer grid 110, the on-diagonal direction refers to on-diagonal direction Ixy of 45° (or) 135°, and off-diagonal direction refers to on-diagonal direction Ixxy or Ixyy other than 45° (or 135°). The principal axis direction, the on-diagonal direction, and the off-diagonal direction each include both the positive (+) direction and the negative (−) direction.

A total of 28 guide tubes are provided in the spacer grid 110. That is, with their arrangement based on the center cell (0,0), eight guide tubes are positioned in the principal axis directions Ixx and Iyy, four in the on-diagonal directions Ixy, and 16 in the off-diagonal directions Ixxy and Ixyy. Meanwhile, as described above, at each guide tube arrangement position of the spacer grid, the guide tube may be directly fixed to the spacer grid or fixed to the spacer grid with the mediation of the sleeve.

The off-diagonal directions Ixxy and Ixyy may be arranged at an equal angle θ based on the on-diagonal direction Ixy. These may include a first off-diagonal direction Ixxy biased toward the x-axis and a second off-diagonal direction Ixyy biased toward the y-axis. In the present embodiment, the first off-diagonal direction Ixxy and the second off-diagonal direction Ixyy may have an angle θ of 18° between each of them and the on-diagonal direction Ixy.

The guide tubes may be arranged at (6,0), (3,0), (−3,0), and (−6,0) in the horizontal direction Ixx and at (0,6), (0,3), (0,−3), and (0,−6) in the vertical direction Iyy.

In addition, the guide tubes may be arranged at (5,5), (−5,−5), (−5,5), (5,−5) in the on-diagonal direction Ixy.

The guide tubes may be arranged at (6,3), (4,2), (−4,−2), and (−6,−3) and at (−6,3), (−4,2), (4,−2) in the first off-diagonal direction Ixxy, and (6,−3) and at (3,6), (2,4), (−2,−4), and (−3,−6) and at (−3,6), (−2,4), (2,−4), and (3,−6) in the second off-diagonal direction Ixyy.

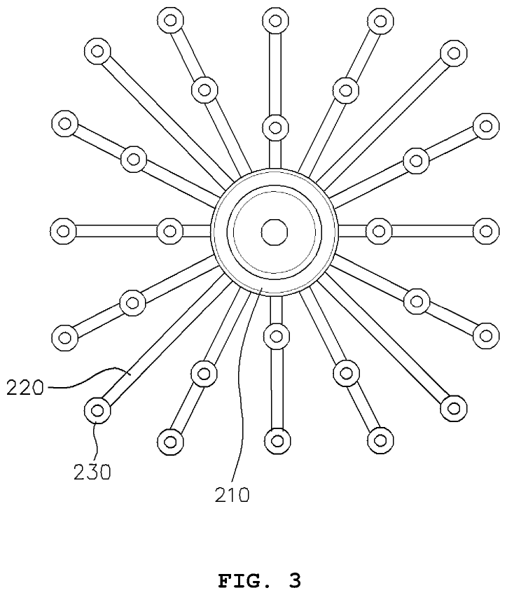

FIG. 3 is a plan view of a control rod assembly according to the embodiment of the present disclosure.

As shown in FIG. 3, a control rod assembly 200, according to an embodiment of the present disclosure, includes: a cylindrical spider body 210; a plurality of spider vanes 220 extending radially from the spider body 210; and a plurality of spider fingers 230, each provided on an associated one of the plurality of spider vanes 220 and configured to respectively fix an associated one of the guide tubes. In addition, each of the spider fingers 230 corresponds to an associated one of the 28 guide tubes described above and is assembled with an associated control rod 210.

In this way, the present disclosure may improve boric acid-free operation and seismic performance by allowing 28 control rods to be inserted at specific locations in the spacer grid having 17×17 lattice cells.

Specifically, from the perspective of the design of the nuclear fuel assembly, it is confirmed that by applying 28 control rods to the nuclear fuel assembly of the 17×17 lattice cell spacer grid, the control rod worth increased by 178, the loading amount of the nuclear fuel decreased by 1.5%, and the seismic performance is improved. In addition, it is confirmed that the reactivity is relatively high, and the core cycle length is increased compared to the conventional nuclear fuel assembly using 24-pin control rods.

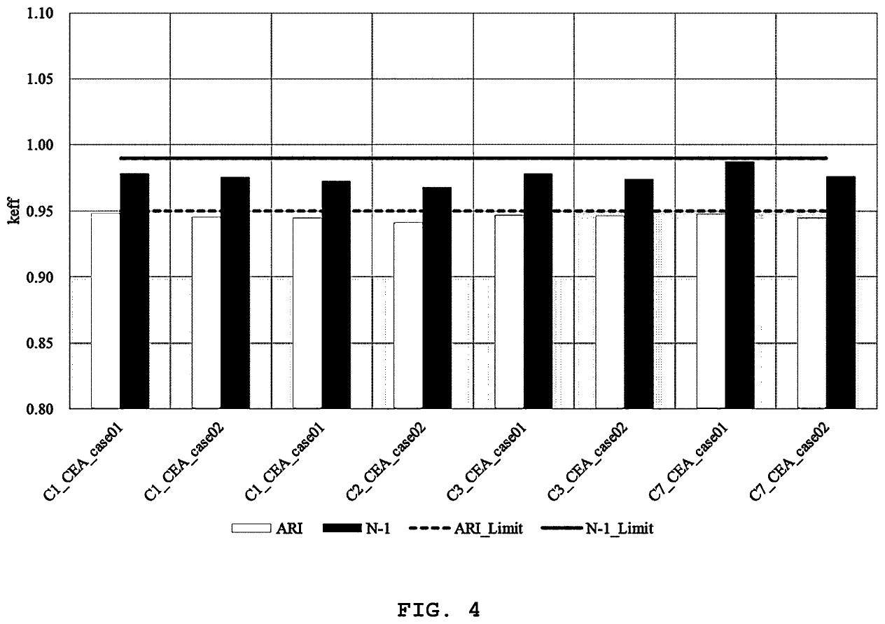

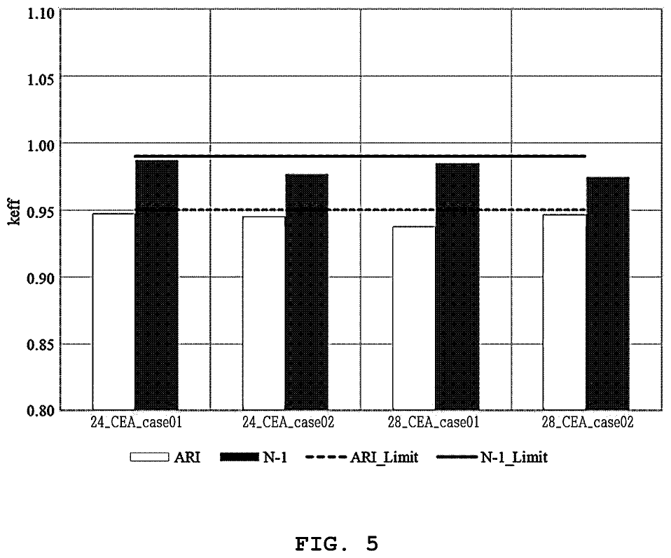

In addition, in the subcriticality evaluation results based on the 24-pin control rod, the effective multiplication factor keff is evaluated to be no greater than 0.95 under the ARI condition and no greater than 0.99 under the N-1 condition, which means that the subcriticality condition is satisfied at a level with almost no margin (see FIG. 4). The results of the subcriticality evaluation based on the 28-pin control rod under conservative conditions were evaluated to have a margin of 0.98 for the effective multiplication factor keff under the N-1 condition (see FIG. 5), Therefore, the safety of a shutdown margin is further strengthened, and 4 additional empty spaces for the top-mounted in-core instrumentation nozzle (TM-ICI) or the control rod assembly may be secured compared to the 24-pin control rod.

Next, from the perspective of mechanical design, the 28-pin control rod is intended to increase the control rod worth in relation to boric acid-free operation, and has the effect of facilitating TM-ICI acceptance and control rod loading/withdrawal. In conventional nuclear power plants, the core reactivity has been controlled by diluting boron, a toxic substance, in the coolant, but this may cause adverse effects such as crud deposition not only on nuclear fuel but also on major reactor core components. The present disclosure requires control of the core reactivity only with a control rod for boron-free operation of a small modular reactor. Therefore, the control rod worth of the present disclosure is increased compared to the existing one, making it effective for boron-free operation.

In addition, the present disclosure may strengthen the mechanical characteristics of the skeleton of a nuclear fuel assembly by increasing the number of guide tubes fixed to the top nozzle and the bottom nozzle.

The present disclosure described above is not limited to the above-described embodiments and the accompanying drawings, and it will be apparent to a person skilled in the art to which the present disclosure pertains that various substitutions, modifications, and changes are possible within a scope that does not depart from the technical spirit of the present disclosure.

What is claimed is:

1. A nuclear fuel assembly comprising:
a spacer grid provided with 17×17 lattice cells;
a plurality of fuel rods, each arranged within an associated lattice cell of the spacer grid;
guide tubes, each arranged and fixed within an associated lattice cell of the spacer grid; and
a top nozzle and a bottom nozzle fixed to an upper end and a lower end of each guide tube, respectively,
wherein, with respect to a center cell of the spacer grid, each of eight guide tubes is arranged in an associated one of principal axis directions Ixx and Iyy, each of four guide tubes in an associated one of on-diagonal directions Ixy, and each of 16 guide tubes in an associated one of off-diagonal directions Ixxy and Ixyy.

2. The nuclear fuel assembly of claim 1, the guide tubes are each arranged at (6,0), (3,0), (−3,0), (−6,0) and (0,6), (0,3), (0,−3), and (0,−6) in an associated one of the principal axis directions,
wherein, in a coordinate system (x, y), x represents a horizontal lattice cell location relative to a center cell (0,0), and y represents a vertical lattice cell location relative to the center cell (0,0).

3. The nuclear fuel assembly of claim 1, the guide tubes are each arranged at (5,5), (−5,−5, (−5,5), and (5,−5) in an associated one of the on-diagonal directions,
wherein, in a coordinate system (x, y), x represents a horizontal lattice cell location relative to a center cell (0,0), and y represents a vertical lattice cell location relative to the center cell (0,0).

4. The nuclear fuel assembly of claim 1, the guide tubes are each arranged at (6,3), (4,2), (−4,−2), (−6,−3), (−6,3), (−4,2), (4,−2), (6,−3), (3,6), (2,4), (−2,−4), (−3,−6), (−3,6), (−2,4), (2,−4), and (3,−6) in an associated one of the off-diagonal directions,
wherein, in a coordinate system (x, y), x represents a horizontal lattice cell location relative to a center cell (0,0), and y represents a vertical lattice cell location relative to the center cell (0,0).

5. A spacer grid assembly comprising:
a spacer grid provided with 17×17 lattice cells;
sleeves, each fixed and assembled within an associated lattice cell of the spacer grid,
wherein, with respect to a center cell of the spacer grid, each of eight sleeves is arranged in an associated one of principal axis directions Ixx and Iyy, each of four sleeves in an associated one of on-diagonal directions Ixy, and each of 16 sleeves in an associated one of off-diagonal directions Ixxy and Ixyy.

6. The spacer grid assembly of claim 5, the sleeves are each arranged at (6,0), (3,0), (−3,0), (−6,0), (0,6), (0,3), (0,−3), and (0,−6) in an associated one of the principal axis directions,
wherein, in a coordinate system (x, y), x represents a horizontal lattice cell location relative to a center cell (0,0), and y represents a vertical lattice cell location relative to the center cell (0,0).

7. The spacer grid assembly of claim 5, the sleeves are each arranged at (5,5), (−5,−5), (−5,5), and (5,−5) in an associated one of the on-diagonal directions,
wherein, in a coordinate system (x, y), x represents a horizontal lattice cell location relative to a center cell (0,0), and y represents a vertical lattice cell location relative to the center cell (0,0).

8. The spacer grid assembly of claim 5, the sleeves are each arranged at (6,3), (4,2), (−4,−2), (−6,−3), (−6,3), (−4,2), (4,−2), (6,−3), (3,6), (2,4), (−2,−4), (−3,−6), (−3,6), (−2,4), (2,−4), and (3,−6) in an associated one of the off-diagonal directions,
wherein, in a coordinate system (x, y), x represents a horizontal lattice cell location relative to a center cell (0,0), and y represents a vertical lattice cell location relative to the center cell (0,0).
